(19) United States
(12) Patent Application Publication
(10) Pub. No.: US 2008/0056287 A1
(43) Pub. Date: Mar. 6, 2008

(54) COMMUNICATION BETWEEN AN INFINIBAND FABRIC AND A FIBRE CHANNEL NETWORK

(75) Inventors: Michael Kagan, Yokneam (IL); Benny Koren, Zichron Yaakov (IL); Dror Goldenberg, Zichron Yaakov (IL); Ido Bukspan, Yehud (IL); Diego Crupnicoff, Buenos Aires (AR)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: MELLANOX TECHNOLOGIES LTD., Yokneam (IL)

(21) Appl. No.: 11/847,367

(22) Filed: Aug. 30, 2007

Related U.S. Application Data
(60) Provisional application No. 60/823,903, filed on Aug. 30, 2006.

(51) Int. Cl. H04L 12/56

(52) U.S. Cl. 370/401

(57) ABSTRACT

A system and method of digital communication wherein a host on an InfiniBand network transmits Fibre Channel packets encapsulated within InfiniBand packets to a gateway which forwards the Fibre Channel packets to Fibre Channel device via a Fibre Channel network, and wherein Fibre Channel packets addressed to a host on an InfiniBand network are transmitted by a Fibre Channel device to a gateway, the gateway encapsulating the Fibre Channel packets within InfiniBand packets and transmitting the InfiniBand packets to an InfiniBand host, where the Fibre Channel packet is extracted.

This is a continuation-in-part of U. S. Provisional Patent Application No. 60/823,903, filed Aug. 30, 2006

### FIELD AND BACKGROUND OF THE INVENTION

The present invention relates to a system and method for digital communication, and, more particularly, to a digital communication system operative to provide devices connected to an InfiniBand fabric with the ability to communicate with devices connected to a Fibre Channel network via a gateway.

Fibre Channel is a network technology currently capable of data transfer rates as high as 10 gigabits/second (10 Gbps), and used primarily for Storage Area Networking. Fibre Channel can be used to implement the transport, link and physical layers of SCSI. InfiniBand is a high-speed switch fabric interconnect architecture. See The InfiniBand Architecture Specification, Release 1.2, http://www.infinibandta.org/specs, which is incorporated by reference for all purposes as if fully set forth herein. The present invention provides end-to-end transport layer connectivity between a compute node on an InfiniBand network and a storage device on a Fibre Channel network, via an associated gateway and associated InfiniBand Host Channel Adapters (HCAs). Optionally, the InfiniBand network can include switches and other network elements between the HCA and the gateway. Optionally, the Fibre Channel network can include switches and other network elements between the storage device and the gateway. Optionally, a Target Channel Adapter (TCA) can take the place of the HCA. Unless otherwise specified, references hereinafter to HCAs also refer to TCAs. In particular, the gateway can be connected to the InfiniBand network via an HCA or via a TCA.

It is known to connect a compute node on an InfiniBand network separately to a Fibre Channel network using a Host Bus Adapter (HBA). This is an expensive solution because each compute node on the InfiniBand network needs its own HBA. At present, HBAs tend to be more expensive than HCAs, and, in a node already equipped with an InfiniBand HCA, it would be desirable to eliminate the need for an HBA if the HCA can provide the same functionality.

It is also known to use a gateway to connect an InfiniBand fabric to a Fibre Channel network. The gateway has its own HBA, or dedicated hardware such as an ASIC or FPGA, operative to connect the gateway to the Fibre Channel network. The gateway is programmed to allow the nodes on the InfiniBand network to share the gateway's HBA. This also is an expensive solution because the gateway hardware and software are necessarily complex. The gateway would have to act as an InfiniBand transport termination and also act as a SCSI transport termination. This requires a large amount of memory because buffers must be maintained as long as the input/output (I/O) operations are in progress.

Optionally, the present invention can be implemented using a prior-art HCA with Fibre Channel emulation driver software that is operative to provide the host with an interface to the HCA that substantially appears to the host as a Fibre Channel interface. Alternatively, an HCA that is enhanced according to the present invention can be used. Such a modified HCA provides the host with an interface that substantially appears to the host as a Fibre Channel interface. Such a modified HCA can significantly reduce the computational burden associated with communication for the host by performing such tasks as segmenting into packets data to be transmitted and re-assembling received data packets. Thus, the host can send the modified HCA a single command to initiate a data transfer, which is then supervised by the modified HCA, and not be disturbed by the data transfer operation until the modified HCA determines that the data transfer operation has been complete, at which time the modified HCA notifies the host via, for example, an interrupt. The nodes of the InfiniBand network can all have prior-art HCAs, all have HCAs modified according to the present invention, or have any mixture of prior-art HCAs and HCAs modified according to the present invention.

The present invention supports the implementation of a gateway that acts as a substantially stateless packet relay to provide end-to-end transport layer connectivity between compute nodes (InfiniBand hosts) and Fibre Channel nodes. An InfiniBand host that wants to exchange data with a Fibre Channel node can run legacy Fibre Channel software, and the host's HCA modified according to the present invention, or, in the case of a prior-art HCA, the host's HCA in association with an above-mentioned Fibre Channel emulation driver, and the gateway take care of all necessary protocol conversions. Unless otherwise specified, all subsequent references herein to a “gateway” are to a gateway modified according to the present invention. Unless otherwise specified, all subsequent references herein to an “HCA” are to an HCA modified in accordance with the present invention or a prior-art HCA in association with a Fibre Channel emulation driver.

The gateway of the present invention transmits data packets individually, rather than treating the data packets as parts of larger data transfers. This eliminates the need for large buffers in the gateway to store transmitted data.

Optionally, data transfers in a system according to the present invention are effected via zero-copy or Remote Direct Memory Access (RDMA) semantics. This provides for more efficient data transfers by eliminating the need for large buffers to store intermediate copies of data, and the time needed to write and read these buffers.

The present invention addresses the problem of high-speed exchange of data between an InfiniBand host and a device on a Fibre Channel network using zero copy or RDMA semantics, thus relieving the processors of much of the burden of information transfer.

The present invention can also be applied to a system where Ethernet or DCE (Data Center Ethernet, also known as Converged Enhanced Ethernet, per IEEE 802.1) is used in place of InfiniBand.

There is thus a widely recognized need for, and it would be highly advantageous to have, a digital communication system that permits devices connected to an InfiniBand fabric to communicate with devices connected to a Fibre Channel network, via a gateway according to the present invention, such that devices on the InfiniBand fabric can use Fibre Channel software to communicate with the gateway via an InfiniBand Host Channel Adapter (HCA) according to the present invention, the HCA being operative to encapsulate Fibre Channel data packets within InfiniBand data packets, thus allowing for transmission of Fibre Channel data packets via the InfiniBand fabric while reducing the burden on the host in dealing with data transfers, such as segmentation of data to be transmitted and re-assembly of received data, and using a simpler, less expensive gateway.

### SUMMARY OF THE INVENTION

According to the present invention there is provided a digital communication system including: (a) a first network operative to transfer a first-network data packet having a first-network data packet format, the first-network data packet format including: (i) a first-network header including a destination address, and (ii) a first-network payload; (b) a second network operative to transfer a second-network data packet having a second-network data packet format, the second-network data packet format including: (i) a second-network header including a destination address, and (ii) a second-network payload; (c) at least one first-network node connected to the first network; (d) at least one second-network node connected to the second network, and (e) a gateway connected as a first-network node of the first network and as a second-network node of the second network, and wherein a first-network node is operative to transmit to the first network a first-network data packet wherein the first-network payload includes a second-network data packet and wherein the destination address of the first-network header includes an address of the gateway, and wherein the gateway is operative to transmit to the second-network node, via the second network, the second-network data packet included in the first-network payload.

Preferably in the system the gateway is responsive to at least one address reserved for the gateway on the second network, and the at least one address reserved for the gateway includes an indication of an address of a first-network node on the first network, and wherein a second-network node is operative to transmit to the second network a second-network data packet wherein the destination address of the second-network header includes an address selected from the at least one address reserved for the gateway, and wherein the indication of an address of a first-network node on the first network is an indication of an address on the first network of a the first-network node, and wherein the gateway is operative to transmit to the first-network node, via the first network, a first-network data packet wherein the destination address included in the first-network header is an address of the first-network node according to the indication of the address on the first network of the first-network node, and wherein the first-network payload includes the second-network data packet.

Preferably in the system the first-network data packet includes a CRC, and the gateway is operative to compute the CRC for the first-network data packet according to the second-network data packet and include the CRC in the first-network data packet.

Preferably in the system the gateway includes a table operative to facilitate mapping of the indication of the address of the first-network node to the address of the first-network node.

Preferably in the system the first network is selected from the group consisting of an InfiniBand network, an Ethernet network and a DCE network.

Preferably in the system the second network is a Fibre Channel network.

According to the present invention there is further provided a digital communication method including the steps of: (a) providing a first network operative to transfer a first-network data packet having a first-network data packet format, the first-network data packet format including: (i) a first-network header including a destination address, and (ii) a first-network payload; (b) providing a second network operative to transfer a second-network data packet having a second-network data packet format, the second-network data packet format including: (i) a second-network header including a destination address, and (ii) a second-network payload; (c) connecting at least one first-network node to the first network; (d) connecting at least one second-network node to the second network; (e) connecting a gateway as a first-network node of the first network and as a second-network node of the second network; (f) the first-network node transmitting to the first network a first-network data packet wherein the first-network payload includes a second-network data packet and wherein the destination address of the first-network header includes an address of the gateway, and (g) the gateway transmitting to the second-network node, via the second network, the second-network data packet included in the first-network payload.

Preferably in the method the gateway is responsive to at least one address reserved for the gateway on the second network, and wherein the at least one address reserved for the gateway includes an indication of an address of a first-network node on the first network, and further including the steps of: (h) the second-network node transmitting to the second network a second-network data packet wherein the destination address of the second-network header includes an address selected from the at least one address reserved for the gateway, and wherein the indication of an address of a first-network node on the first network is an indication of an address on the first network of a first-network node, and (i) the gateway transmitting to the first-network node, via the first network, a first-network data packet wherein the destination address included in the first-network header is an address of the first-network node according to the indication of the address on the first network of the first-network node, and wherein the first-network payload includes the second-network data packet.

Preferably in the method the first network is selected from the group consisting of an InfiniBand network, an Ethernet network and a DCE network.

Preferably in the method the second network is a Fibre Channel network.

### BRIEF DESCRIPTION OF THE DRAWINGS

The invention is herein described, by way of example only, with reference to the accompanying drawings, wherein:

FIG. 1 (prior art) shows schematically the structure of a Fibre Channel data packet.;

FIG. 1a (prior art) shows schematically the structure of a Fibre Channel that has been translated to 10-bit coding with 10-bit SOF and EOF codes added;

FIG. 2 (prior art) shows schematically the structure of an InfiniBand packet;

FIG. 3 shows schematically the structure of a Fibre Channel packet with added eSOF and and eEOF codes encapsulated as the payload of an InfiniBand packet;

FIG. 4 shows schematically the structure of a digital communication system according to the present invention.

### DESCRIPTION OF THE PREFERRED EMBODIMENTS

The present invention is of a digital communication system and method wherein a compute node (InfiniBand host) that has an appropriately modified HCA, or a prior-art HCA in association with a Fibre Channel emulation driver, can efficiently communicate with devices on a Fibre Channel network.

Specifically, the present invention can be used to provide for end-to-end connectivity between a compute node and a device on a Fibre Channel network via the HCA and a gateway. Data transfer is preferably accomplished using zero-copy or RDMA semantics, significantly reducing the burden on the compute node and the gateway data processors.

The principles and operation of a communication system and method according to the present invention may be better understood with reference to the drawings and the accompanying description.

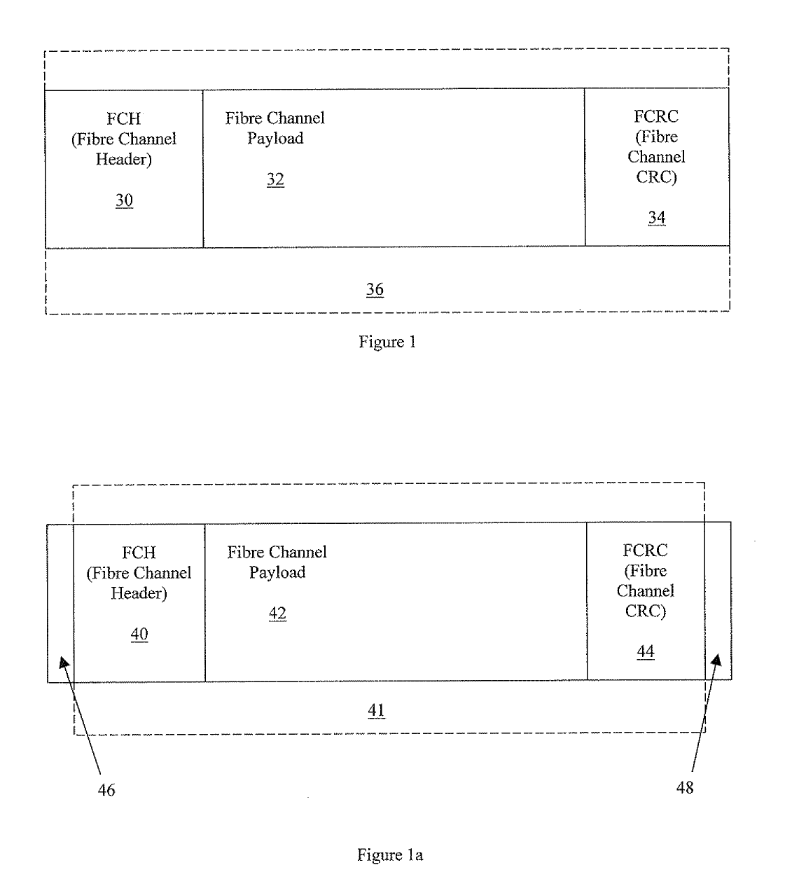

Referring now to the drawings, FIG. 1 shows schematically the structure of a Fibre Channel data packet 36. A Fibre Channel Header (FCH) 30 includes fields such as a destination identification (ID) and a source ID. An FCRC (Fibre Channel Cyclic Redundancy Code) 34 is a cyclic redundancy code (CRC) for packet 36.

To facilitate transport via the physical medium, Fibre Channel employs an 8 bit/10 bit coding scheme, wherein each eight bits of the Fibre Channel packet are translated to a ten-bit code. Some ten-bit codes that are not used to represent eight-bit data are used for special purposes, such as marking the start and end of a packet. FIG. 1a shows schematically a ten-bit encoded Fibre Channel packet 41 which includes a ten-bit start-of-field (SOF) code 46 and a ten-bit end-of-field (EOF) code 48.

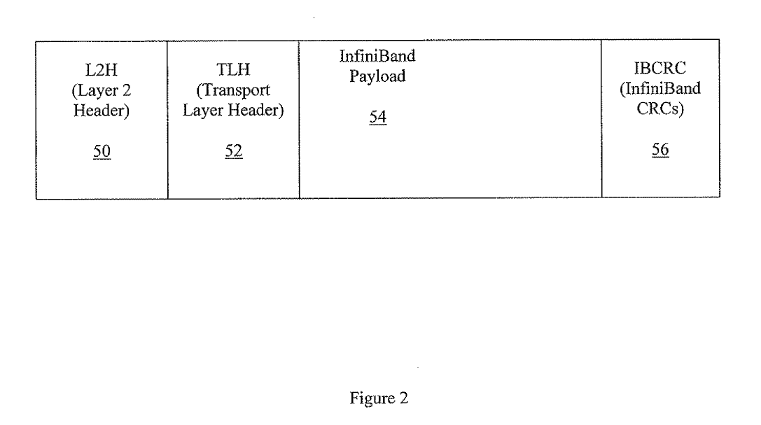

FIG. 2 shows schematically the structure of a prior-art InfiniBand data packet. A Layer 2 Header (L2H) 50, also called a “Local Routing Header” (LRH) in the InfiniBand specification, an optional Layer 3 Global Routing Header (GRH), not shown, and a Transport Layer Header (TLH) 52 provide routing information for the packet. A field IBCRC (InfiniBand CRCs) 56 includes CRCs for the packet. Payload field 54 includes user data.

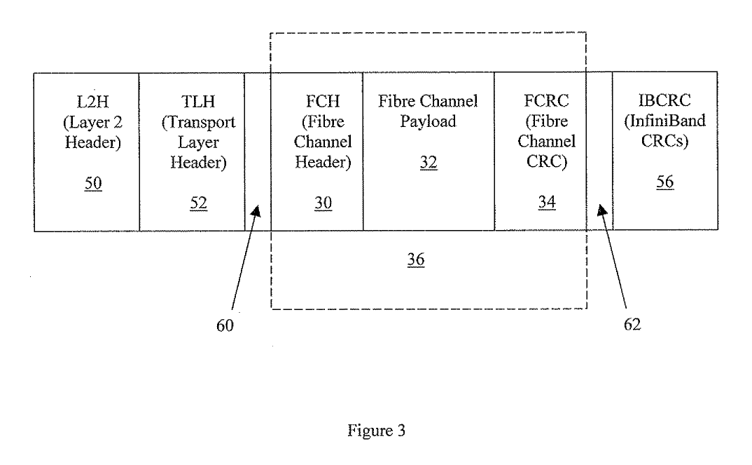

FIG. 3 shows schematically the structure of a Fibre Channel data packet 36 encapsulated within an InfiniBand data packet, according to the present invention.

Because the ten-bit special codes, such as the SOF 46 and EOF 48 of FIG. 1b are not represented by eight bit codes, these special codes are represented by additonal fields of eight-bit data, such as eSOF (encapsulation SOF) 60 and eEOF (encapsulation EOF) 62, when a Fibre Channel data packet 36 is encapsulated within an InfiniBand data packet according to the present invention. The packet of FIG. 3 is the packet of FIG. 2 with packet 36 of FIG. 1, along with the above-mentioned additional fields 60 and 62, as its payload. Fibre Channel payload 32 of FIG. 3 is the payload that is actually exchanged between an InfiniBand node and a Fibre Channel node. Unless otherwise specified, all subsequent references herein to an “InfiniBand packet” are to the packet of FIG. 3.

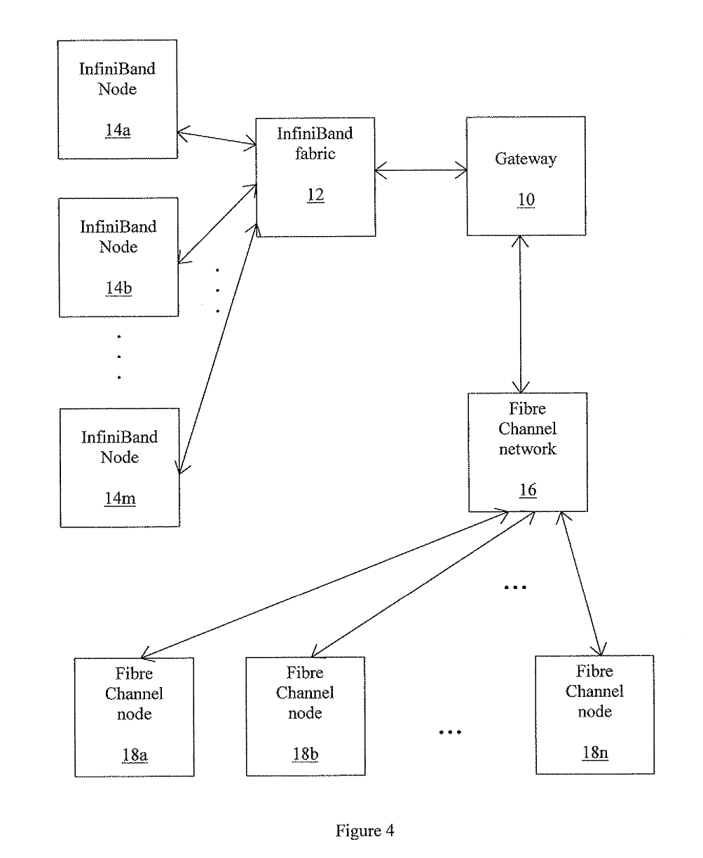

FIG. 4 is a high-level block diagram of a digital communication system according to the present invention.

When gateway 10 receives an InfiniBand packet from InfiniBand fabric 12, gateway 10 just extracts Fibre Channel packet 36 from InfiniBand packet payload 54 and sends Fibre Channel packet 36 to the Fibre Channel wire with the destination specified by the destination ID of the FCH 30.

For transfers via gateway 10 from InfiniBand fabric 12 to Fibre channel network 16, the InfiniBand packets include the gateway Queue Pair (QP), which causes these packets to be transmitted to gateway 10. Gateway 10 extracts Fibre Channel frame 36 from the InfiniBand packet and sends Fibre Channel frame 36 to Fibre Channel network 16.

For transfers via gateway 10 from Fibre Channel network 16 to InfiniBand network 12, gateway 10 locates the Destination ID (DID) field in the packet, looks up the DID in a lookup table, which provides destination information for the packet, such as the destination QPN (QP Number), SL, LID, PKey, etc. Gateway 10 then encapsulates Fibre Channel frame 36 into an InfiniBand packet, and transmits the packet to InfiniBand network 12.

Flow in the gateway is thus very simple. The packet provides the information necessary to route the packet to the destination. There is no need for large intermediate buffers. The only data repository needed is the simple table containing the mapping of the DID to QPN, SL, LID and Pkey.

For transmission from a node, or host, 14 of a packet destined for delivery to a Fibre Channel device, the HCA composes a Fibre Channel packet 36, and encapsulates Fibre Channel packet 36 within an InfiniBand packet. The destination of the InfiniBand packet will be gateway 10, as determined by LID, QPN and SL. The packet is sent with an InfiniBand source QPN that reflects the Fibre Channel application, which is a dummy QPN, as explained below. The packet is then sent to InfiniBand network 12.

When a host 14 receives a packet from InfiniBand fabric 12, host 14 checks if the QPN is the dummy QPN mentioned above, which indicates that the packet is a Fibre Channel over InfiniBand (FCoIB) packet. If not, the packet is handled as an ordinary InfiniBand packet. If the packet is an FCoIB packet the HCA decapsulates the encapsulated Fibre Channel packet 36 and handles the packet as would a prior-art Fibre Channel HBA. Offloading of the work for the host by the HCA is accomplished by mapping Fibre Channel packets into InfiniBand RDMA semantics and thus the host processor is spared such chores as segmentation, reassembly, data placement with zero copy, transport checks, excessive interrupts, etc.

Within the HCA FCP_CMND, FCP_RSP and FCP_CONF are mapped into IB SEND. FCP_DATA is mapped into RDMA Read Response for I/O Write, and into IB RDMA WRITE for I/O Read. FCP_XFER_RDY is mapped into IB RDMA Read. This provides for correct placement of data, and for segmentation and reassembly in an InfiniBand HCA.

Gateway 10 needs at least a single QP number for FCoIB. Optionally, gateway 10 can have other QP numbers for configurations etc. All hosts 14 will send to this QP number for FCoIB. Optionally, multiple QP numbers can be used for this purpose. All hosts 14 have a QP number per “virtual adapter”. If a host 14 wants more than one virtual adapter the host 14 will use more QPs. When host 14 sees packets on those QPs, it means to the host that Fibre Channel packets are coming. Similarly for sending, host 14 will send include in the packet the QP number that corresponds to the appropriate virtual Fibre Channel adapter.

FC exchanges, part of the Fibre Channel transport, are internally mapped into QPs. The QP context is also extended by an affiliated Memory Region (MR) that describes the user buffer of the I/O operation. The association is one-to-one. For example, exchange number x, QO number (prefix, x}, MR number {prefix, x}. Thus, the necessary resources can easily be located when processing packets. Exchange number xx is mapped into QPN {prefix,xx}. When a packet arrives if the HCA identifies that the packet is an FCoIB packet the HCA extracts the exchange number from the packet and directs it to a QPN calculated as explained. The QPN contains all context required to process the incoming packet: transport check, to detect missing or bad frames, destination memory address, etc.

While the invention has been described with respect to a limited number of embodiments, it will be appreciated that many variations, modifications and other applications of the invention may be made.

What is claimed is:

1. A digital communication system comprising:
(a) a first network operative to transfer a first-network data packet having a first-network data packet format, said first-network data packet format including:
(i) a first-network header including a destination address, and
(ii) a first-network payload;
(b) a second network operative to transfer a second-network data packet having a second-network data packet format, said second-network data packet format including:
(i) a second-network header including a destination address, and
(ii) a second-network payload;
(c) at least one first-network node connected to said first network;
(d) at least one second-network node connected to said second network, and
(e) a gateway connected as a first-network node of said first network and as a second-network node of said second network,
and wherein a said first-network node is operative to transmit to said first network a first-network data packet wherein said first-network payload includes a second-network data packet and wherein said destination address of said first-network header includes an address of said gateway, and wherein said gateway is operative to transmit to said second-network node, via said second network, said second-network data packet included in said first-network payload.

2. The system of claim 1, wherein said gateway is responsive to at least one address reserved for said gateway on said second network, and wherein said at least one address reserved for said gateway includes an indication of an address of a first-network node on said first network, and wherein a said second-network node is operative to transmit to said second network a second-network data packet wherein said destination address of said second-network header includes an address selected from said at least one address reserved for said gateway, and wherein said indication of an address of a first-network node on said first network is an indication of an address on said first network of a said first-network node, and wherein said gateway is operative to transmit to said first-network node, via said first network, a first-network data packet wherein said destination address included in said first-network header is an address of said first-network node according to said indication of said address on said first network of said first-network node, and wherein said first-network payload includes said second-network data packet.

3. The system of claim 2, wherein said first-network data packet includes a CRC, and wherein said gateway is operative to compute said CRC for said first-network data packet according to said second-network data packet and include said CRC in said first-network data packet.

4. The system of claim 2, wherein said gateway includes a table operative to facilitate mapping of said indication of said address of said first-network node to said address of said first-network node.

5. The system of claim 1, wherein said first network is selected from the group consisting of an InfiniBand network and a DCE network.

6. The system of claim 1, wherein said second network is a Fibre Channel network.

7. A digital communication method comprising the steps of:
(a) providing a first network operative to transfer a first-network data packet having a first-network data packet format, said first-network data packet format including:
(i) a first-network header including a destination address, and
(ii) a first-network payload;
(b) providing a second network operative to transfer a second-network data packet having a second-network data packet format, said second-network data packet format including:
(i) a second-network header including a destination address, and
(ii) a second-network payload;
(c) connecting at least one first-network node to said first network;
(d) connecting at least one second-network node to said second network;
(e) connecting a gateway as a first-network node of said first network and as a second-network node of said second network;
(f) said first-network node transmitting to said first network a first-network data packet wherein said first-network payload includes a second-network data packet and wherein said destination address of said first-network header includes an address of said gateway, and
(g) said gateway transmitting to said second-network node, via said second network, said second-network data packet included in said first-network payload.

8. The method of claim 7, wherein said gateway is responsive to at least one address reserved for said gateway on said second network, and wherein said at least one address reserved for said gateway includes an indication of an address of a first-network node on said first network, and further comprising the steps of:
(h) said second-network node transmitting to said second network a second-network data packet wherein said destination address of said second-network header includes an address selected from said at least one address reserved for said gateway, and wherein said indication of an address of a first-network node on said first network is an indication of an address on said first network of a said first-network node, and
(i) said gateway transmitting to said first-network node, via said first network, a first-network data packet wherein said destination address included in said first-network header is an address of said first-network node according to said indication of said address on said first network of said first-network node, and wherein said first-network payload includes said second-network data packet.

9. The method of claim 7, wherein said first network is selected from the group consisting of an InfiniBand network, an Ethernet network and a DCE network.

10. The system of claim 7, wherein said second network is a Fibre Channel network.
